(19) United States
(12) Patent Application Publication
(10) Pub. No.: US 2015/0136797 A1
(43) Pub. Date: May 21, 2015

(54) THERMAL INSULATED CONTAINER

(71) Applicant: SCUBE GIFT PTE LTD, Singapore (SG)

(72) Inventor: Kenneth Jun Hui LI, Singapore (SG)

(73) Assignee: SCUBE GIFT PTE LTD, Singapore (SG)

(21) Appl. No.: 14/081,527

(22) Filed: Nov. 15, 2013

(51) Int. Cl. A47J 41/00; B65D 51/24

(52) U.S. Cl. CPC A47J 41/0077; B65D 51/248
USPC 220/592.26

(57) ABSTRACT

A thermal insulated container is provided. The container includes a cup-shaped inner vessel disposed within a stainless steel outer vessel and a lid. The inner vessel comprises bone china and a vacuum chamber is formed in between the inner vessel and the outer vessel.

### TECHNICAL FIELD

The present invention relates to thermal insulated containers. In particular, this invention relates to thermal insulated containers for containing hot or cold beverages.

### BACKGROUND

Insulated containers are useful for keeping one's beverage hot or cold, for later consumption.

A known container comprises a stainless steel inner cup and a stainless steel outer finishing. A problem with such a container is that the inner cup may corrode with prolonged use, which in turn makes the container unsafe for further use.

Another known container comprises an inner cup made of glass. A disadvantage of glass is its fragility. A further drawback is the porosity of glass which causes it to retain the smell of the beverage, hence not allowing the container to be used for a different beverage immediately.

It is also often convenient to know the temperature of a beverage in a container so that one can consume the beverage without scalding one's lips. However, simply knowing the temperature is not adequate. Certain beverages, such as tea, have an optimum steeping period. Hence, knowing the right time to consume the beverage will provide a more palatable experience for consumers.

Thus, what is needed is a thermal insulated container that overcomes the above disadvantages or at least provide a novel thermal insulated container.

Furthermore, other desirable features and characteristics will become apparent from the subsequent detailed description and the appended claims, taken in conjunction with the accompanying drawings and this background of the disclosure.

### SUMMARY OF INVENTION

According to an embodiment of the invention, a thermal insulated container is described, the container having a cup-shaped inner vessel disposed within a stainless steel outer vessel and a lid, wherein the inner vessel comprises bone china and a vacuum chamber is formed in between the inner vessel and the outer vessel.

Preferably, the container further comprises a temperature sensor and a temperature indicator.

Preferably, the container further comprises a timer and a timing indicator.

Preferably, the bone china comprises at least one of cow bone, phosphorus, potassium, carbon, hydrogen, oxygen and nitrogen.

Preferably, the cow bone makes up 25% to 45% of bone china.

Preferably, the width of the vacuum chamber is 0.5 mm to 2.5 mm.

Preferably, the outer vessel comprises Su304 stainless steel.

Preferably, the outer vessel has a thickness of 0.2 mm to 1.5 mm.

Preferably, the inner vessel has a thickness of 1 mm to 4 mm.

The invention will now be described in detail with reference to the accompanying drawings.

### BRIEF DESCRIPTION OF DRAWINGS

The accompanying figures, where like reference numerals refer to identical or functionally similar elements throughout the separate views and which together with the Detailed Description below are incorporated in and form part of the specification, serve to illustrate various embodiments and to explain various principles and advantages in accordance with a present embodiment.

FIG. 1 is a cross-sectional view of a thermal insulated container in accordance with the present embodiment.

FIG. 2 is a top view of a lid of the thermal insulated container of FIG. 1.

Skilled artisans will appreciate that elements in the figures are illustrated for simplicity and clarity and have not necessarily been depicted to scale. For example, the dimensions of some of the elements may be exaggerated in respect to other elements to help to improve understanding of the present embodiments.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description. It is the intent of this invention to present a thermal insulated container.

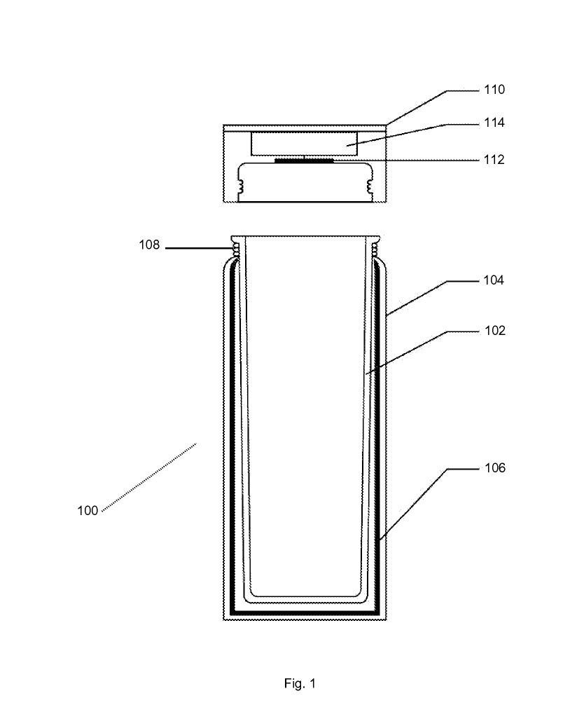

Referring to FIG. 1, a cross-sectional view of thermal insulated container 100, in accordance with the present embodiment, is shown. Container 100 comprises cup-shaped inner vessel 102 disposed within stainless steel outer vessel 104. Vacuum chamber 106 is formed in between inner vessel 102 and outer vessel 104.

Inner vessel 102 comprises bone china, also known as soft-paste porcelain. Preferably, bone china comprises animal bone, phosphorus, potassium, carbon, hydrogen, oxygen and nitrogen. Preferably, 25% to 45% of the composition of bone china is made up of animal bone. Preferably, the animal bone is cow bone. Bone china is non-porous. Advantageously, this makes bone china retain heat better, thus enabling a beverage to be kept warm or cold for a longer duration of time. A further advantage of bone china's non-porosity ensures that it retains minimal smell and preserves the authentic taste of a beverage. Bone china does not cause any chemical reaction with the contents of container 100. Therefore, consumers are safe from any harmful chemical reaction, such as corrosion, when utilising container 100.

Bone china is also easy to clean, thus allowing container 100 to be re-used immediately without much hassle. Another advantage of bone china is that it is chip-resistant, making container 100 sturdy for everyday use. Another advantage of the bone china is that it is light weight. The weight of inner vessel 102 comprising bone china can be between 120 g to 300 g. As such, a typical weight of container 100 can be between 200 g to 800 g. Preferably, inner vessel 102 has a thickness of between 1 mm to 4 mm. Preferably, inner vessel 102 has a diameter of between 5 cm to 10 cm. Preferably, inner vessel 102 has a height of between 12 cm to 20 cm.

In a preferred embodiment, vacuum chamber 106 lines inner vessel 102. Vacuum chamber 106 provides insulation to the contents of inner vessel 102. Preferably, the width of vacuum chamber 106 is 0.5 mm to 2.5 mm. The combination of inner vessel 102 made up of bone china and vacuum chamber 106, can allow the contents (e.g. beverages) of container 100 to be kept warm or cold for 3 to 10 hours.

Preferably, stainless steel outer vessel 104 has a thickness of 0.2 mm to 1.5 mm. Preferably, stainless steel type Su304 is used. Stainless steel outer vessel 104 further reinforces container 100 making it more durable. Also outer vessel 104 will not rust despite frequent washing.

Container 100 also comprises lid 110. Lid 110 seals container 100. Lid 110 engages threads of rim 108. This “screw-type” engagement minimises leakage of the contents of container 100 and ensures that the contents within container 100 are kept warm or cold for a longer period of time. It is obvious to one skilled in the art that a “snap-fit” engagement or any other equivalent can be used in place of the “screw-type” engagement.

In a preferred embodiment, lid 110 can also comprise temperature sensor 112 and temperature indicator 114. Temperature sensor 112 is located on an interior surface of lid 110, and temperature sensor 112 takes the ambient temperature of the inside of container 100 by means of a thermometer, which then relays this information to temperature indicator 114.

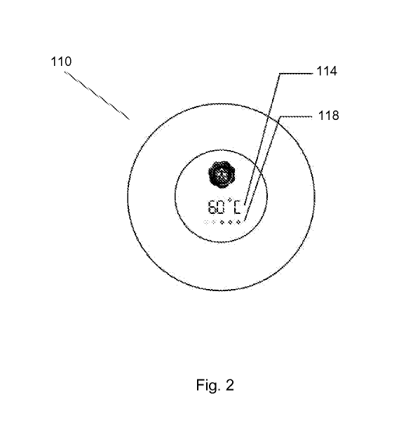

Referring to FIG. 2, a top-view of lid 110 is shown. Temperature indicator 114 is disposed on an exterior surface of lid 110. Preferably, temperature indicator 114 is a Light Emitting Diode (LED). Temperature indicator 114 can display the measured temperature numerically.

The advantage of having temperature indicator 114 is to prevent one from accidentally drinking a beverage that is too hot. Temperature indicator 114 also serves as a form of reminder for one to consume the beverage before it gets too cold. Though it has been shown in the figures that temperature sensor 112 and temperature indicator 114 are located on lid 110, one skilled in the art can fully appreciate that temperature sensor 112 and temperature indicator 114 can be located elsewhere on container 100.

Container 100 can also comprise timer 116 (not shown in figures) and timing indicator 118. Certain beverages such as tea have preferred steeping periods. The advantage of having timer 116 is to track the time that has elapsed, and provide this information to the consumer via timing indicator 118. The consumer would therefore know when the tea has undergone the preferred steeping period, and consume the tea only then, which enhances the overall drinking experience.

Timer 116 can either be set according to a user's desired timing by adjusting the timer settings or it may already have been pre-set at the time of purchase. Timer 116 can be activated manually or automatically. For example, automatic activation of timer 116 can be initiated when lid 110 engages threads of rim 108. Timing indicator 118 can display the time that has elapsed numerically or graphically (as shown in FIG. 2). Timing indicator 118 in FIG. 2 is illustrated with five oval-shaped LEDs, whereby the number of oval-shaped LEDs being lit will signify the time that has elapsed. For example, if all five oval-shaped LEDs are lit, this is the indication that the steeping period is over and the tea can be consumed.

The combination of temperature indicator 114 and timing indicator 118 on container 100 is advantageous in that it allows a consumer to know when it is ideal to drink the beverage. For example, tea taste best at 70 degrees Celsius and cannot brew or steep more than 10 minutes. The benefit is that consumers will be able to ascertain the temperature of the beverage via the temperature indicator 114 and the time that has elapsed via the timing indicator 118, and start to drink the beverage only at the ideal time.

Thus, it can be seen that a novel thermal insulated container has been provided.

The invention described herein is susceptible to variations, modifications and/or additions other than those specifically described and it is to be understood that the invention includes all such variations, modifications and/or additions which fall within the scope of the following claims.

1. A thermal insulated container comprising:
a cup-shaped inner vessel disposed within a stainless steel outer vessel; and
a lid;
wherein the inner vessel comprises bone china and a vacuum chamber is formed in between the inner vessel and the outer vessel.

2. The thermal insulated container according to claim 1, further comprising a temperature sensor and a temperature indicator.

3. The thermal insulated container according to claim 2, further comprising a timer and a timing indicator.

4. The thermal insulated container according to claim 3, wherein bone china comprises at least one of cow bone, phosphorus, potassium, carbon, hydrogen, oxygen and nitrogen.

5. The thermal insulated container according to claim 4, wherein the cow bone makes up 25% to 45% of bone china.

6. The thermal insulated container according to claim 3, wherein the width of the vacuum chamber is 0.5 mm to 2.5 mm.

7. The thermal insulated container according to claim 3, wherein the outer vessel comprises Su304 stainless steel.

8. The thermal insulated container according to claim 3, wherein the outer vessel has a thickness of 0.2 mm to 1.5 mm.

9. The thermal insulated container according to claim 3, wherein the inner vessel has a thickness of 1 mm to 4 mm.
